(19) United States
(12) Patent Application Publication
(10) Pub. No.: US 2017/0169197 A1
(43) Pub. Date: Jun. 15, 2017

(54) METHOD FOR CUSTOMIZING RESTRICTED DESKTOP ON MOBILE TERMINAL AND MOBILE TERMINAL THEREOF

(71) Applicants: Le Holdings (Beijing) Co., Ltd., Beijing (CN); Lemobile Information Technology (Beijing) Co., Ltd., Beijing (CN)

(72) Inventor: Dan JIANG, Beijing (CN)

(21) Appl. No.: 15/250,830

(22) Filed: Aug. 29, 2016

Related U.S. Application Data
(63) Continuation of application No. PCT/CN2016/088837, filed on Jul. 6, 2016.

(30) Foreign Application Priority Data
Dec. 12, 2015 (CN) 201510921290.8

(51) Int. Cl. G06F 21/30; G06F 21/62

(52) U.S. Cl. CPC G06F 21/30; G06F 21/629

(57) ABSTRACT

Disclosed are a method for customizing a restricted desktop on a mobile terminal and the mobile terminal thereof. The method includes: pre-configuring a customized restricted desktop application, and setting, upon successful password verification from the customized restricted desktop application, at least one guest desktop in the customized restricted desktop application; entering the guest desktop for the mobile terminal user failing to pass the password verification from the customized restricted desktop application uses, and, unrestrictedly entering, upon successful password verification of the customized restricted desktop application, any desktop of the customized restricted desktop application, for the mobile terminal user having the password of the customized restricted desktop application, wherein the any desktop of the customized restricted desktop application comprising a normal desktop. According to the present disclosure, privacy of a user may be well protected while guest's use requirements are satisfied.

### CROSS REFERENCE TO RELATED APPLICATIONS

This present disclosure is a continuation of International Application No. PCT/CN2016/088837, filed on Jul. 6, 2016, which is based upon and claims priority to Chinese Patent Application No. 201510921290.8, filed on Dec. 12, 2015, the entire contents of which are incorporated herein by reference.

### TECHNICAL FIELD

The disclosure relates to the technical field of mobile terminals, and more particularly, to a method for customizing a restricted desktop on a mobile terminal and the mobile terminal thereof.

### BACKGROUND

Mobile terminals refer to terminal products mounted with an open operating system which provide services for users by using broadband wireless mobile communications technology to access the Internet, and downloading and installing application software and digital content, for example, mobile phones, tablet computers and the like.

With the development of technologies, the mobile terminals are indispensable in people's daily life, and record various of information, including privacy information that cannot be viewed by others or information that cannot be viewed by children.

In daily life, some scenarios may be present, for example:

Software specific for children's learning are installed on mobile phones, and thus the mobile phones need to be taken by the children. However, the mobile phones may not be freely played by the children due to some important data information or some information unsuitable for the children to view.

If your friend whose mobile phone encounters a fault desires to borrow your mobile phone to check his or her Microblog, friends circle or access the Internet, your may be probably feel awkward to do since a lost of private information is stored on your mobile phone.

A merchant, for example, a museum, develops a new application which presents multi-language introductions of a plurality of exhibitions, exquisite videos and the like. However, considering the copyrights, the merchant does not want provide such information for a user by means of downloading by the user going online, and thus the application is installed on a smart phone. After the user attends the exhibition hall, the merchant leases the smart phone to the user. However, since the smart phone is mounted with a lot of other applications, it is not convenient for the user to use the smart phone.

At present, a solution to this problem is to use Android L. Android is a free and open source operating system based on Linux. Android L is an upgraded version of an Android system. Compared with the Android system, Android L has a new user interface, and enhanced performance and cross-platform support capability. In addition, Android L has enhanced battery life and deeper application integration.

Android L supports multi-user functionality. Each user has his or her own applications, wallpaper and settings. In addition, when the user access the computer, the user can only see files and data relevant to the current user. Data between the users, including storage data and data of the applications are substantially independent of each other. In brief, an Android L multi-user system has the characteristics of; multi-user settings and independency of the data in multiple user modes. For example, in a guest mode, such personal data as calls, short messages, notes and picture libraries may be hidden to protect privacy of the owner of the mobile phone.

The multi-user functionality of Android L is implemented based on the framework of Android L, and is thus powerful. However, such powerful functionality generally needs support of hardware. The Android L functionality is not supported by all the mobile phones. For example, low-end smart phones generally do not support the Android L mechanism, and thus the demands on the multi-user functionality may not be accommodated.

### SUMMARY

The present disclosure provides a method for customizing a restricted desktop on a mobile terminal and the mobile terminal thereof. By means of setting a customized guest desktop, a guest is capable of only using a preset guest desktop application, such that privacy of the user is well protected while guest's use requirements are satisfied.

An embodiment of the present disclosure provides a method for customizing a restricted desktop on a mobile terminal, including: pre-configuring a customized restricted desktop application, and setting, upon successful password verification from the customized restricted desktop application, at least one guest desktop in the customized restricted desktop application; entering the guest desktop, for the mobile terminal user failing to pass the password verification from the customized restricted desktop application uses; and unrestrictedly entering, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

An embodiment of the present disclosure provides a mobile terminal for customizing a restricted desktop, including: at least one processor; and a memory communicably connected with the at least one processor for storing instructions executable by the at least one processor, wherein execution of the instructions by the at least one processor causes the at least one processor to; pre-configure a customized restricted desktop application, and set, upon successful password verification from the customized restricted desktop application, at least one guest desktop in the customized restricted desktop application; enter the guest desktop, for the mobile terminal user failing to pass the password verification from the customized restricted desktop application uses; and unrestrictedly enter, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

An embodiment of the present disclosure provides a non-transitory computer-readable storage medium storing executable instructions that, when executed by an electronic device with a touch-sensitive display, cause the electronic device to: pre-configure a customized restricted desktop application, and setting at least one guest desktop in the customized restricted desktop application upon successful password verification of the customized restricted desktop application; enter the guest desktop, for the mobile terminal user failing to pass the password verification from the customized restricted desktop application uses; and unrestrictedly enter, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating a method for customizing a restricted desktop on a mobile terminal according to a specific embodiment of the present disclosure;

FIG. 2 is a detailed schematic flowchart illustrating a method for customizing a restricted desktop on a mobile terminal according to a specific embodiment of the present disclosure; and

FIG. 3 is a schematic flowchart illustrating a mobile terminal for customizing a restricted desktop according to a specific embodiment of the present disclosure;

FIG. 4 is a schematic structural diagram illustrating an electronic device according to the present disclosure.

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

### Embodiment 1

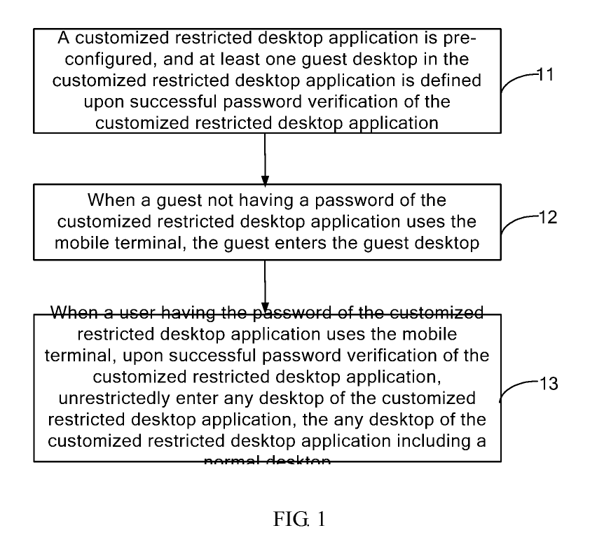

FIG. 1 is a schematic flowchart illustrating a method for customizing a restricted desktop on a mobile terminal according to a specific embodiment of the present disclosure.

As illustrated in FIG. 1, the method is applied to a mobile terminal and includes the following steps:

In step S11, a customized restricted desktop application is pre-configured, and at least one guest desktop in the customized restricted desktop application is defined upon successful password verification of the customized restricted desktop application.

In step S12, when a guest not having a password of the customized restricted desktop application uses the mobile terminal, the guest enters the guest desktop.

In step S13, when a user having the password of the customized restricted desktop application uses the mobile terminal, upon successful password verification of the customized restricted desktop application, the user unrestrictedly enters any desktop of the customized restricted desktop application, the any desktop of the customized restricted desktop application including a normal desktop.

It should be noted that step S12 and step S13 are not subjected to an execution sequence, which are merely for exemplifying different application scenarios.

### Embodiment 2

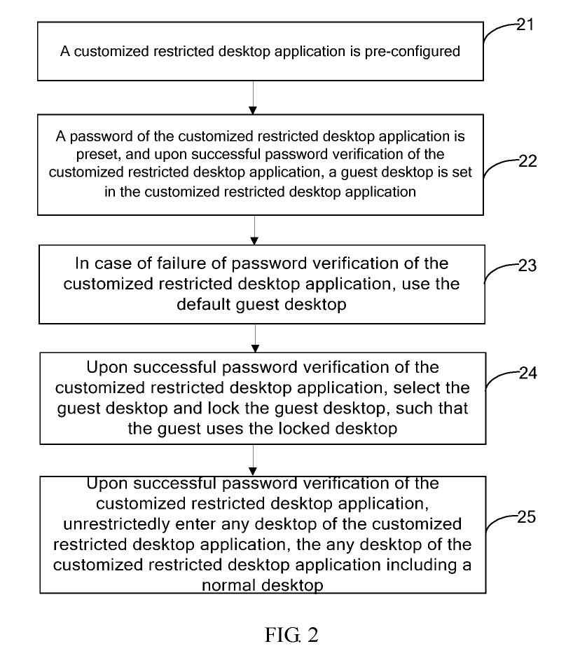

FIG. 2 is a detailed schematic flowchart illustrating a method for customizing a restricted desktop on a mobile terminal according to a specific embodiment of the present disclosure.

As illustrated in FIG. 2, the method is applied to a mobile terminal and includes the following steps:

In step S21, a customized restricted desktop application is pre-configured.

In this step, a system-level application needs to be developed in advance, for example, for example, a customized restricted desktop application. The customized restricted desktop application is located in a system directory on the mobile terminal for ease of acquiring an access permission.

In step S22, a password of the customized restricted desktop application is preset, and upon successful password verification of the customized restricted desktop application, a guest desktop is set in the customized restricted desktop application.

In this step, the password of the customized restricted desktop application needs to be preset, and upon successful password verification of the customized restricted desktop application, the guest desktop and available applications on the guest desktop may be customized.

Specifically, the guest desktop is newly created in the customized restricted desktop application, an application to be used by the guest is selected from applications installed on the mobile terminal, and the selected application is added to the newly created guest desktop. Upon the setting, a white list of the guest desktop is formed, which may be stored in the shared preference of the application.

For example, a guest desktop specific to children may be customized, which includes some applications of small games and learning; a guest desktop specific to friends may be customized, which includes such applications as WeChat, QQ, video websites and the like that are not logged in ever before; and the number of customized desktops may be more than one, which is not described herein any further. In addition, a user may perform edit, delete and add operations any time upon successful password verification of the customized restricted desktop application.

Further, to prevent the user from entering the other restricted applications by using the Home key, the multi-tasks key, the notification of the status bar and the like way, the code needs to be processed as follows:

To prevent the user from restarting the mobile phone to return to the normal desktop, the code of the guest desktop is set to a default launcher desktop.

Prior to entering the guest desktop, all the history tasks are cleared, and as such the user may not see the previous tasks when clicking the multi-task key.

To prevent the status bar from being dropped down, a reflection method may be used, and the disable function of the application in a status bar manager is called, for example, disable (StatusBarManager.DISABLE_EXPAND) of android.app.StatusBarManager.

In step S23, in case of failure of password verification of the customized restricted desktop application, a user uses the default guest desktop.

In this step, a mobile terminal user may set a guest desktop, and uses the guest desktop as a default guest desktop; or the mobile terminal user may set a plurality of guest desktops, and select one from the plurality of guest desktops as a default guest desktop.

If the guest has taken the mobile terminal, but fails to pass the password verification of the customized restricted desktop application, that is, user operations of the mobile terminal are not performed, but the default guest desktop may only be used. As such, the guest may not select other guest desktops.

In step S24, upon successful password verification of the customized restricted desktop application, the user selects the guest desktop and locks the guest desktop, such that the guest uses the locked desktop.

In this step, if the user presets different guest desktops, the guest may request the user to enter a guest desktop suitable for the guest.

Specifically, the user is subjected to password verification of the customized restricted desktop application, selects a guest desktop suitable for the guest from the plurality of guest desktops upon successful password verification of the customized restricted desktop application, and locks the guest desktop. In this way, the guest is capable of only entering the locked guest desktop, but fails to enter the other guest desktops.

In step S25, upon successful password verification of the customized restricted desktop application, the guest unrestrictedly enters any desktop of the customized restricted desktop application, wherein the any desktop of the customized restricted desktop application includes a normal desktop.

In this step, if the guest returns the mobile terminal to the user after use, the user needs to be subjected to password verification of the customized restricted desktop application again.

In case of successful password verification of the customized restricted desktop application, the user may select any of the desktops existing in the application, for example, the normal desktop. As such, the user may return to the normal desktop and uses the normal desktop, which is the same as the state before the mobile phone is handed over to the guest.

### Embodiment 3

FIG. 3 is a schematic flowchart illustrating a mobile terminal for customizing a restricted desktop according to a specific embodiment of the present disclosure.

As illustrated in FIG. 3, the mobile terminal according to the present disclosure includes:

a first processing module 31, adapted to pre-configure a customized restricted desktop application, and setting at least one guest desktop in the customized restricted desktop application upon successful password verification of the customized restricted desktop application;

a second processing module 32, adapted to: when a guest not having a password of the customized restricted desktop application uses the mobile terminal, enter the guest desktop; and when a user having the password of the customized restricted desktop application uses the mobile terminal, upon successful password verification of the customized restricted desktop application, unrestrictedly enter any desktop of the customized restricted desktop application, the any desktop of the customized restricted desktop application including a normal desktop.

To be specific:

The first processing module 31 is adapted to pre-configure a customized restricted desktop application, wherein the customized restricted desktop application is a system-level application developed in advance. The customized restricted desktop application may be located in a system directory on the mobile terminal for ease of acquiring an access permission.

The first processing module 31 is further adapted to preset a password of the customized restricted desktop, upon successful password verification of the customized restricted desktop application, select to newly create the guest desktop in the customized restricted desktop application; and select, from applications installed on the mobile terminal, an application to be used by the guest, and add the selected application to the newly created guest desktop; wherein upon the setting, a white list of the guest desktop is formed, which may be stored in the shared preference of the application.

The second processing module 32 is adapted to: use a default guest desktop in case of failure of password verification of the customized restricted desktop application, a user uses the default guest desktop, wherein a guest fails to enter the other guest desktops, or fails to enter the unrestricted normal desktop; and if the user presets different desktops, select a guest desktop and locks the guest desktop upon successful password verification of the customized restricted desktop application, and use the locked guest desktop, wherein in this case, the guest is still in capable of entering the unrestricted normal desktop; and unrestrictedly enter any desktop in the customized unrestricted desktop application upon successful password verification of the customized restricted desktop application, for example, the normal desktop.

According to the present disclosure, a customized restricted desktop application is pre-configured, at least one guest desktop is set in the customized restricted desktop application upon successful password verification of the customized restricted desktop application, such that when a guest not having a password of the customized restricted desktop application uses the mobile terminal, a user is capable of only entering the guest desktop; and when a user having the password of the customized restricted desktop application uses the mobile terminal, upon successful password verification of the customized restricted desktop application, the user is capable of unrestrictedly entering any desktop of the customized restricted desktop application.

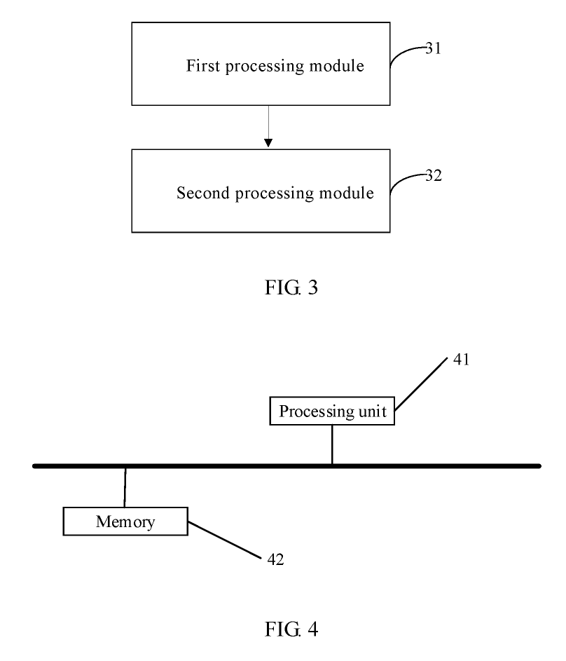

Referring to FIG. 4, another embodiment of the present disclosure further provides a mobile terminal, which has the same functions as those of the mobile terminal illustrated in FIG. 3. The device as illustrated in FIG. 4 includes at least one central processing unit 41 and a memory 42. The memory 42 and the at least one central processing unit 41 are connected via a bus. The memory 42 is configured to store computer instructions. When the mobile terminal is executed, the at least one central processing unit 41 performs the computer instructions stored in the memory to cause the mobile terminal to perform the steps in the methods as illustrated in FIG. 1 and FIG. 2.

Another embodiment of the present disclosure further provides a non-transitory computer-readable storage medium storing executable instructions that, when executed by an electronic device, cause the electronic device to: pre-configuring a customized restricted desktop application, and setting at least one guest desktop in the customized restricted desktop application upon successful password verification of the customized restricted desktop application; when a guest not having a password of the customized restricted desktop application uses the mobile terminal, entering the guest desktop; and when a user having the password of the customized restricted desktop application uses the mobile terminal, upon successful password verification of the customized restricted desktop application, unrestrictedly entering any desktop of the customized restricted desktop application, the any desktop of the customized restricted desktop application comprising a normal desktop.

As compared with the related art, according to the present disclosure, a system framework does not need to be modified, instead the user may freely set a customized guest desktop as long as a system-level application “customized restricted desktop” only needs to be installed in a mobile terminal. In this way, the guest may only use the pre-configured guest desktop application, and thus privacy of the user is well protected while guest's use requirements are satisfied.

The above described mobile terminal embodiments are merely for illustration purpose only. The modules which are described as separate components may be physically separated or may be not physically separated, and the components which are illustrated as modules may be or may not be physical modules, that is, the components may be located in the same position or may be distributed into a plurality of network modules. A part or all of the modules may be selected according to the actual needs to achieve the objectives of the technical solutions of the embodiments. Persons of ordinary skill in the art may understand and implement the present disclosure without paying any creative effort.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a computer readable storage medium. The computer readable storage medium includes any mechanism for storing or transferring information in a computer readable form, such as a ROM/RAM, a magnetic disk, a CD-ROM and the like, including several instructions for causing a computer device (a personal computer, a server, or a network device) to perform the methods in various embodiments of the present disclosure, or in certain portions of the embodiments of the present disclosure.

It should be finally noted that the above-described embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of the technical features contained therein. Such modifications or replacement, made without departing from the principles of the present invention, shall fall within the scope of the present disclosure.

What is claimed is:

1. A method for customizing a restricted desktop on a mobile terminal, comprising:
pre-configuring a customized restricted desktop application, and setting, upon successful password verification from the customized restricted desktop application, at least one guest desktop in the customized restricted desktop application;
entering the guest desktop, for the mobile terminal user failing to pass the password verification from the customized restricted desktop application uses; and
unrestrictedly entering, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

2. The method for customizing a restricted desktop on a mobile terminal according to claim 1, wherein the step of setting, upon successful password verification from the customized restricted desktop application, at least one guest desktop in the customized restricted desktop application comprises:
presetting a password of a customized restricted desktop;
upon successful password verification of the customized restricted desktop application, selecting to newly create the guest desktop in the customized restricted desktop application; and
selecting, from applications installed on the mobile terminal, an application to be used by the guest, and adding the selected application to the newly created guest desktop.

3. The method for customizing a restricted desktop on a mobile terminal according to claim 2, wherein the method further comprises:
setting a default guest desktop in the newly created guest desktop; and
entering the default guest desktop when the guest not having the password of the customized restricted desktop application uses the mobile terminal.

4. The method for customizing a restricted desktop on a mobile terminal according to claim 3, wherein the method further comprises:
entering the default guest desktop upon restart of the mobile terminal;
prior to entering the guest desktop, clearing all the history tasks; and
calling a disable function of the application in a status bar manager of the mobile terminal to prevent a status bar of the application from being dropped down.

5. The method for customizing a restricted desktop on a mobile terminal according to claim 1, wherein the method further comprises:
upon successful password verification of the customized restricted desktop application, selecting, by a user, the guest desktop and locking the guest desktop, such that the guest uses the locked desktop.

6. A mobile terminal for customizing a restricted desktop, comprising:
at least one processor; and
a memory communicably connected with the at least one processor for storing instructions executable by the at least one processor, wherein execution of the instructions by the at least one processor causes the at least one processor to:
pre-configure a customized restricted desktop application, and set, upon successful password verification from the customized restricted desktop application, at least one guest desktop in the customized restricted desktop application;
enter the guest desktop, for the mobile terminal user failing to pass the password verification from the customized restricted desktop application uses; and
unrestrictedly enter, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

7. The mobile terminal for customizing a restricted desktop according to claim 6, wherein the instructions to set, upon successful password verification from the customized restricted desktop application, at least one guest desktop in the customized restricted desktop application cause the at least one processor to:
preset a password of a customized restricted desktop;
upon successful password verification of the customized restricted desktop application, select to newly create the guest desktop in the customized restricted desktop application; and
select, from applications installed on the mobile terminal, an application to be used by the guest, and add the selected application to the newly created guest desktop.

8. The mobile terminal for customizing a restricted desktop according to claim 7, wherein, the at least one processor is further caused to:
define a default guest desktop in the newly created guest desktop; and
enter the default guest desktop when the guest not having the password of the customized restricted desktop application uses the mobile terminal.

9. The mobile terminal for customizing a restricted desktop according to claim 8, wherein, the at least one processor is further caused to:
enter the default guest desktop upon restart of the mobile terminal;
prior to entering the guest desktop, clear all the history tasks; and
call a disable function of the application in a status bar manager of the mobile terminal to prevent a status bar of the application from being dropped down.

10. The mobile terminal for customizing a restricted desktop according to claim 6, the at least one processor is further caused to:
upon successful password verification of the customized restricted desktop application, select the guest desktop and locking the guest desktop, such that the guest uses the locked desktop.

11. A non-transitory computer-readable storage medium storing executable instructions that, when executed by an electronic device, cause the electronic device to:
pre-configure a customized restricted desktop application, and set, upon successful password verification from the customized restricted desktop application, at least one guest desktop in the customized restricted desktop;
enter the guest desktop, for the mobile terminal user failing to pass the password verification from the customized restricted desktop application uses; and
unrestrictedly enter, upon successful password verification of the customized restricted desktop application, any desktop of the customized restricted desktop application, for the mobile terminal user having the password of the customized restricted desktop application, wherein the any desktop of the customized restricted desktop application comprising a normal desktop.

12. The non-transitory computer-readable storage medium according to claim 11, wherein the instructions to set, upon successful password verification from the customized restricted desktop application, at least one guest desktop in the customized restricted desktop cause the at least one processor to:
preset a password of a customized restricted desktop;
upon successful password verification of the customized restricted desktop application, select to newly create the guest desktop in the customized restricted desktop application; and
select, from applications installed on the mobile terminal, an application to be used by the guest, and add the selected application to the newly created guest desktop.

13. The non-transitory computer-readable storage medium according to claim 12, wherein, the at least one processor is further caused to:
define a default guest desktop in the newly created guest desktop; and
enter the default guest desktop when the guest not having the password of the customized restricted desktop application uses the mobile terminal.

14. The non-transitory computer-readable storage medium according to claim 13, wherein, the at least one processor is further caused to:
enter the default guest desktop upon restart of the mobile terminal;
prior to entering the guest desktop, clear all the history tasks; and
call a disable function of the application in a status bar manager of the mobile terminal to prevent a status bar of the application from being dropped down.

15. The non-transitory computer-readable storage medium according to claim 11, the at least one processor is further caused to:
upon successful password verification of the customized restricted desktop application, select the guest desktop and locking the guest desktop, such that the guest uses the locked desktop.
